(19) United States
(12) Patent Application Publication
(10) Pub. No.: US 2013/0079228 A1
(43) Pub. Date: Mar. 28, 2013

(54) Agricultural spray solution compositions and methods

(71) Applicant: Brian E. Freed, Lexington, IL (US)

(72) Inventor: Brian E. Freed, Lexington, IL (US)

(21) Appl. No.: 13/200,443

(22) Filed: Sep. 23, 2011

(51) Int. Cl. A01N 25/02; A01N 57/20; A01N 37/02; A01N 37/46; A01N 47/36; A01N 31/14; A01N 59/26; A01N 43/66; A01P 13/00; A01P 1/00; C05C 3/00; C05B 7/00; C05C 1/00; C05C 9/00; B05D 7/00; A01N 25/30

(52) U.S. Cl. 504/206; 504/362; 504/363; 514/769; 504/325; 504/322; 504/214; 504/212; 504/351; 424/605; 504/231; 71/61; 71/34; 71/59; 71/28; 71/64.1; 71/64.07; 427/212

(57) ABSTRACT

An agrichemical is disclosed having increased bio-activity which is adapted for spray application in a form which offers reduced aerial drift and improved deposition on organisms, reduced agglomeration and gellation problems, is adapted for use with chemicals, pesticides and fertilizers and allows for lower agrichemical use rates. Various adjuvants and surfactants are combined with fertilizers or pesticides, such as herbicides fungicides and insecticides, to reduce application problems relating to droplet size, foaming, chemical stability, plant and area coverage, droplet drift, surface tension, suspension, incompatability, phytoxicity, solubility, volatilization and evaporation, while providing enhanced bio-efficacy and low aquatic toxicity. Purifying the agrichemical composition water source by any of various known processes such as oxidation, ultra-filtration, deionization, reverse osmosis or nanofiltration lowers or removes alkaline components, such as calcium, magnesium, iron, sodium, etc., and reduces water hardness, and further increases the agrichemical's bio-efficacy.

### FIELD OF THE INVENTION

This invention relates generally to agricultural chemistry, and is particularly directed to agricultural chemicals such as pesticides, fertilizers and bio-active plant altering compositions which are particularly adapted for spray application to organisms and which provide increased efficiency, efficacy and agricultural production.

### BACKGROUND OF THE INVENTION

Modern agriculture makes use of agricultural chemicals and formulations such as pesticides, fertilizers and adjuvants which are formulated so that they can be easily mixed with water and applied typically by spraying to cover plants and other target organisms. The spray is in the form of a mist of fine particles containing the bio-active agricultural chemicals and formulations. These biologically active foliar chemicals are frequently combined with additives to enhance performance. While small droplets provide better coverage of target plants, they also are more susceptible to drift than larger droplets. It has been found that particles less than about 150 microns in diameter exhibit excessive drift, while droplets larger than about 400 microns provide reduced coverage, with both extremes resulting in reduced spray efficiency.

Ammonium sulfate is a commonly used fertilizer which also exhibits enhanced herbicide and pesticide performance. Polyacrylamide suspensions/emulsions and guar gum or guar gum derivatives, such as hydroxypropyl guar, have been used as deposition enhancement agents for spray applications. When polyacrylamide and guar dry particles are hydrated, if they are not very small initially, they swell to form “fish eyes” which can block in-line screens and nozzles, resulting in pressure buildup in the system and irregular spray patterns. In addition, when spray droplets hit and remain on a target organism, rather than bounce or run off, there is enhanced transmission of the bioactive chemicals to the target organism. The extent of the anti-bounce and run off effect is a function of droplet size, mass, elasticity and adhesive properties.

Various adjuvants and surfactants are typically incorporated in agricultural chemicals such as pesticides and fertilizers to improve the performance of the pesticide/fertilizer droplet after it is deposited on a plant or other organism. For example, a sticker-spreader material may be used with a pesticide/fertilizer to increase the area that a droplet of a given spray mixture will cover on a target organism and to assist the spray droplet to adhere, or stick, to the target organism as long as possible for increased transmission of the active agricultural chemicals to the target organism. A sticker material is generally in the form of a hydrophobic film-former that requires the use of emulsifiers or a surfactant for dispersal in water and for the initial application. The surfactant also provides a spreader functionality in these products.

In addition to the spreading, sticking, solubility and drift characteristics discussed above, various other adjuvants are added to agricultural chemicals to enhance wetting, emulsifying, dispersing and biological activity. Adjuvants include wetting agents, crop oil concentrates, buffering agents, foaming and anti-foaming agents, dispersing agents and anti-shear agents, as well as those agents discussed above relating to drift, droplet size and viscosity characteristics.

Petroleum hydrocarbon spray oils are known to increase the efficacy of pesticides by improving the deposition, wetting and spreading characteristics of the spray solutions so as to produce uniform and more even spray deposit or by increasing the biological efficacy of the agricultural spray. Such petroleum hydrocarbon-based spray oils can also increase plant penetration and slow evaporation in increasing the efficacy of desired agricultural chemicals. Buffering agents maintain the pH of the mixture within a desired pH range in the presence of alkaline water typically used in agricultural spray solutions. For example, diammonium sulfate can be used as a substrate for certain solid nonionic surfactants when the surfactant composition is dry bonded onto a large percentage of the fertilizer particles by spray-coating the fertilizer with a molten surfactant to facilitate complete dissolution of the solid, non-ionic surfactant compositions. In addition, pH buffers such as fatty acid esters are used as a dry water-soluble nitrogen fertilizer coating which is readily soluble in water at the time of application to plants in a field. Sorbitan and phosphate esters are known to improve the bio-performance of an adjuvant composition comprised primarily of paraffin oil by reducing the pH of the composition to a desired range of 4-6. In addition, adjuvant compositions used as buffering agents and comprised of vegetable oils, fatty acids and blends thereof, esterified and saponified fatty acids and blends thereof are used to reduce the pH of the composition to about 7 or less to prevent hydrolysis and increase the efficacy of pesticides.

There is a growing trend to combine herbicides with adjuvants for increasing the efficacy of the herbicide. In one approach to combining herbicides with adjuvants, adjuvants are developed as separate compositions which are added to the herbicide at the time of use. Another approach involves combining herbicides with adjuvants in developing formulations which contain the herbicide as well as the adjuvant. Substances which can be used as adjuvants include ammonium salts and other plant nutrients, various wetting agents and spray drift retardants, as well as lipophilic solvents. Ammonium salts are believed to minimize the negative effects of hard water on herbicidal performance and to provide nutrition to the plant. Wetting agents improve the leaf coverage of the herbicide. Lipophilic solvents maintain the herbicide in liquid form because the herbicide is ineffective if it dries on the foliage and also facilitate penetration of the herbicide into the plant. Various surfactants have been incorporated in herbicides to either increase or decrease various characteristics of the herbicide depending upon the application. For example, the free acid forms and their corresponding salts have been proposed for addition to a herbicide such a glyphosate to allow for lower glyphosate use rates than standard formulations. These acids in free form include acetic, citric, phosphoric, propionic and sulfuric acids, and their corresponding salts. Other surfactants used with herbicides include various surfactant components such as amine-based surfactants to form herbicidal compositions having a reduced tendency to cause eye and skin irritation while controlling unwanted weeds or vegetation. Still other surfactants added to water soluble herbicides form efficacious compositions which are low in aquatic toxicity. These surfactants are selected from the group consisting of alkyldiamine tetra alkoxylate surfactants, N-alkyl alkyldiamine trialkoxylate surfactants, and phosphated alcohol alkoxylate surfactants.

The present invention addresses all of the areas of agricultural composition and performance discussed above, as well as additional areas relating to these types of biologically active products. This invention addresses each of the pesticide/fertilizer areas discussed above and provides improvements in these performance areas not heretofore realized. These improvements are in the areas of pesticide/fertilizer preparation, handling, storage, usage, efficacy, safety and environmental considerations and economics.

### OBJECTS AND SUMMARY OF THE INVENTION

The issue of water hardness as it relates to its negative effect on fertilizer and pesticide performance has heretofore been addressed by adding various components to preferentially combine with and attempt to deactivate the cationic metal ions in order to prevent the cationic metal ions from combining with and deactivating pesticides, fertilizers and bio-active agents in the water used for agricultural chemical applications.

These techniques have resulted in various degrees of success. All of these techniques fail to accomplish complete, or even substantially complete, removal of water hardness. One reason for this lack of substantial removal of hardness in processed water is the presence of compounds in the water formed by deactivating the cationic metal ions which remain in the water, such as in the form of a spray solution, and interfere with the uptake of the pesticide, fertilizer or bio-active agent into the target pest or cultivated plant. These cationic metal-based compounds have a higher molecular weight than the other components of the water and settle first on the bottom of the individual spray droplets. It is frequently this portion of the spray droplet which first contacts the surface of the target pest or cultivated plant. This situation interferes with and may prevent the adsorption on and/or absorption into the intended target organism.

Accordingly, it is an object of the present invention to provide agricultural spray compositions having reduced drift characteristics, increased bio-activity and which allow for the use of lower agricultural chemical use rates.

It is another object of the present invention to provide water-soluble nitrogen-containing fertilizers adapted for incorporation in aqueous spray mixtures completely and rapidly to provide a sprayable foliar agricultural medium characterized by reduced drift and the absence of clumping, gellation and agglomeration for ease of handling in dry form.

A further object of the present invention is to provide water-soluble, nitrogen-containing foliar fertilizers with drift reduction agents, such as guar gum, and also having enhanced hydration rates with reduced agglomeration and gellation even when introduced rapidly into a highly-agitated, aqueous agricultural medium, with a silicone defoaming agent either encapsulated or absorbed in an agriculturally-acceptable carrier, incorporated in the mixture.

Yet another object of the present invention is to provide a convenient and easy-to-use fertilizer composition which affords reduced off-target drift and improved droplet deposition on the targeted plants and other organisms as well as extended droplet retention on the plants and improved plant penetration.

A further object of the present invention is to improve the chemical and physical properties of a pesticide, such as a herbicide, insecticide or fungicide, in spray form containing a spray oil by adding a surfactant having various compositions such as vegetable oils, fatty acids or esterified fatty acids, and mixtures thereof, and a buffering agent for maintaining the mixture within a designated pH range.

A still further object of the present invention is to provide surface adjuvants for use in various foliar pesticides, particularly herbicides, which are sufficiently hydrophilic to stabilize in water and lipophilic enough to penetrate the cuticle of a leaf.

Another object of the present invention is to provide buffering agents for agricultural solutions, such as pesticides, which when added to an agricultural spray so as to provide the spray solution with a pH within a designated range, provide for the emulsification and more uniform coverage of the spray solution, improved plant or other organism penetration, and slower evaporation from the targeted plants.

Still another object of the present invention is to add an acid, such as for example acetic, citric, phosphoric or sulfuric acid, to a glyphosate-based herbicide to permit lower glyphosate use rates than standard formulations, and a surfactant to reduce the surface tension of water in the solution to allow water in the herbicide to penetrate the outer skin of the undesirable target vegetation.

Therefore, the present invention contemplates a method for preparing an agricultural composition for use with a pesticide, fertilizer and/or bio-active agent comprising the steps: providing water purified to have on the order of about 1 to 100 ppm total dissolved solids by substantially removing hardness and alkalinity from unpurified water; and adding a buffering agent to the purified water to reduce divalent metal ion concentration of the purified water and increase the efficacy of the pesticide, fertilizer and/or bio-active agent. This invention further contemplates adding to the purified water either in combination or individually ammonium salts including urea ammonium nitrate, wetting agents, spray drift retardants, lipophilic solvents, oil soluble bases, micro-emulsions, nonionic and/or cationic emulsifiers, defoaming agents and organic acids. This invention further contemplates various combinations of the individual steps described above, including methods involving a reduced number of steps. The invention involves the preparation and use of biologically active foliar products/agents which, in some cases, are combined with additives to enhance pesticide, fertilizer or bio-active agent performance. The additives include, but are not limited to, ammonium salts including urea ammonium nitrate, wetting agents, spray drift retardants, lipophilic solvents, oil soluble bases, micro-emulsions, nonionic and/cationic emulsifiers, defoaming agents and organic acids, used either in combination or individually.

### DETAILED DESCRIPTION OF THE PREFERRED EMBODIMENTS

The agrichemicals of the present invention are in the form of foliar pesticides or fertilizers, or a combination of these two agricultural applications, and are broad in scope as they provide improvements in a wide range of characteristics of these types of products. Each embodiment of Applicant's invention and the agrichemical characteristics which it improves are discussed in detail below, with several embodiments disclosed for improving the same characteristic in many cases.

Embodiments of the present invention include improved pesticides or fertilizers compositions and their preparation and use. Some embodiments are based, at least in part, on the discovery that the use of water purified to reduce total dissolved solids content (TDS) is beneficial in enhancing efficacy and efficiency. Purified water having a suitably low level of TDS for such applications can be achieved through any of several methods. In a preferred embodiment, the purified water is also subjected to a reduction of at least 96-97% of hardness and alkalinity from normal tap water.

Dissolved solids to be removed can include minerals such as one or more of iron, calcium, magnesium, sodium and others (including organics and other non-minerals). The degree of TDS removal generally depends on the level of initial TDS, the removal steps, and the desired final application. Typically available water supplies often have TDS levels in the range of 250-600 ppm, with potable water usually having TDS of less than 500 ppm. While invention embodiments will achieve the greatest benefit with the lowest levels of TDS possible, achieving very low levels of TDS often entails high removal efforts, high removal costs and long processing times that can be disadvantageous. In many applications, a case of diminishing returns is encountered at some point.

Within the scope of the present invention, useful levels of removal have been discovered that offer important advantages in terms of balancing costs with performance. For example, many (but not all) invention embodiments include steps of reducing water TDS to no more than 100 ppm. TDS reduction to this level has been discovered to strike an advantageous balance between cost and benefit. In other invention embodiments, steps of reducing TDS to no more than 50 ppm, to no more than 20 ppm, to no more than 10 ppm, and to no more than 5 ppm are performed. Levels of 10 ppm or less have been observed to offer very significant benefit in invention embodiments, but in some (although not all) cases achieving this level of purity may lead to disadvantageous costs. Again, final level of TDS depends to a considerable extent on initial TDS levels.

Achieving TDS levels of 10 ppm or less may be practical when an initial sample has no more than 250 ppm TDS, but may be impractical if the initial sample contains 600 ppm TDS. In some invention embodiments, further steps may be performed of measuring initial water TDS levels and starting with water that has no more than 250 ppm, no more than 300 ppm, no more than 40 ppm, or no more than 500 ppm TDS.

With regard to the particular removal steps performed, multiple different removal processes can be applied including but not limited to, filtration (such as micro or nanofiltration), distillation (such as steam distillation), reverse osmosis, electrolysis, and others. Filtration includes directing the water through one or more filtering media to remove particulates and other materials, including dissolved solids. Filter media can be selected based on the size of particulate desired to be removed. In the case of dissolved solids, micro or nano filtration methods can be used with media having pore sizes that may be, for example, of the order of several microns or less. Polymer membranes, ceramics, and solid block carbon are some examples of suitable media for performing micro or nano filtration.

Reverse osmosis is believed to be a particularly useful removal method in many invention embodiments since it can achieve beneficial levels of TDS removal at costs that are often more reasonable than other removal procedures. Reverse osmosis utilizes very small pore size filter media, which are typically a polymer membrane (referred to as a semi-permeable). Membrane pores are sized to allow water molecules to pass but to prevent passage of larger molecules of salts and other dissolved solids. Reverse osmosis is the opposite of osmosis—the natural flow of a solvent (often water) from a membrane side having a lower solute concentration (i.e., more pure) across a semi-permeable membrane to a higher solute concentration (i.e., less pure). Reverse osmosis uses pressure to drive the opposite flow from the more concentrated (e.g., higher TDS) to the more pure (e.g., lower TDS) state. Pressure is applied at a level that exceeds the natural osmotic pressure to drive the process.

Reverse osmosis membranes are typically made of polymers, with some made from one polymer and others including polymer composites. Semi-permeable membranes of different materials, pore sizes and configurations can be used to filter out dissolved solids. Example membrane materials include cellulose tri-acetate, thin film composite, polyamide, polysulfone, and others. Membrane pore size may be selected as desired for particular purity ranges, and in many applications can vary from tenths or smaller of a nanometer to thousands of nanomaters. Many reverse osmosis membranes have pore sizes to remove particles 0.1 nm or larger. Other pore sizes will also be useful. Commercial reverse osmosis membranes are widely available from many companies including the Dow Chemical Company, Midland, Mich. Such membranes often feature a tube-flow design.

Distillation generally includes boiling high TDS water to create water vapor (steam), and then collecting and condensing the vapor to result in purified low TDS water. Because of the need to boil and condense water, distillation can carry high energy requirements resulting in relatively high operation costs. Electrolysis includes the decomposition of water into oxygen and hydrogen due to an electric current being passed through the water. The components can be recombined to form purified water. Like distillation, electrolysis can involve significant energy costs and may be economically impractical in some applications.

It has been discovered that removal of some minerals offer more significant benefit than others in invention embodiments. In many embodiments removal of iron, in particular, offers significant benefit and more benefit than any other single mineral. Removal of other minerals has been discovered to offer benefit according to the following priority (beginning with the most significant benefit): calcium, magnesium, and sodium. While removal of all mineral or other TDS is often desired, for cost or other reasons it may be desirable to focus on removal of only one or more selected minerals. Accordingly, some invention embodiments exploit this discovery by utilizing particular filtration or other removal methods that focus on removing only one, only two, only three or other numbers of dissolved solid components. As an example, some invention embodiments may include steps of using a manganese oxide bed to remove iron (with much less removal achieved of other TDS components).

This invention contemplates the use of cross-linked sulfonated polystyrene granules (soil conditioner) with three different absorptions of deionized water on the dissolution of three different K₂SO₄ fertilizers. One of the fertilizers is water soluble, while the other two are controlled-release fertilizers with different nutrient release rates. For the water-soluble fertilizer, the quantities of K leached from soil columns increased with the absorption capacity of the polymers. In the case of the application of polymer with the highest absorption capacity (100 g of water g⁻¹ dry polymer), water-soluble K leached was 188% more than that leached from controlled-release formulations. The presence of hydrogels in the soil increases dissolution of controlled-release fertilizers.

Applicant's invention further contemplates the use of drift management adjuvants on the atomization, drift, patternation, retention, deposit formation, and efficacy of an herbicide spray. The drift of the spray particles decreases by suppressing the formation of fine droplets, i.e., <150 microns in diameter. The impact of drift reducing additives on pesticide efficacy in terms of the effect on the major phases, i.e., the larger droplets, on the dose transfer process is also considered. Two representative drift reducing adjuvants, i.e., (1) polyacrylamide polymers represented by Nalcotrol or Nalcotrol II (N or N2), and (2) biodegradable polymers represented by AgRHO DR-2000 (DR) of Rhone-Poulenc Inc. were considered in mixtures containing glyphosate.

N2 polymers lose much of their drift-reducing capability after several recirculations through a vane pump. DR is not affected by pump shear stress and reduces particle drift even after multiple recirculations. Pattern distributions undergo significant deviations from even distributions using herbicide alone when polymers are added. Sheared and unsheared DR provides drift control equivalent to unsheared N2. 30% less spray is reflected from the cabbage leaves from mixtures containing DR compared to either water alone or water containing polyacrylamide polymers. Spray retention is reduced by the addition of drift reducing adjuvants. DR is better at wetting the cabbage leaves. Drift rate values are significantly lower for glyphosate plus DR than for glyphosate alone. The efficacy of glyphosate on velvetleaf is enhanced by the presence of drift reducing adjuvants, especially DR. Losses in dose transfer efficiency caused by uneven spray distribution patterns are offset by enhanced spray adhesion and active ingredient uptake by the target plants.

The addition of gel-forming hydrophilic polymers to nitrogen (N) fertilizer solutions reduces N leaching loss and increases plant uptake of N. Urea ammonium nitrate (UAN, 32% N) mixed with a variety of polymers at three concentrations, and applied to a sandy soil and leached weekly for six weeks improves fertilizer performance. N not only is temporarily retained against loss, but it is released in a timely manner to meet the nutritional demands of the growing crop. N leaching losses were reduced in the amount of 0-45% during the first four weeks due to polymer addition, compared with UAN alone. A reduction of N leaching losses of an average of 26, 16, 7, and 7% for the first four weeks following fertilizer application is realized with the addition of polymer. The addition of a stabilizer such as Na₂S₂O₃ has a further beneficial impact on reducing N losses. Na₂S₂O₃ improves the ability of modified guar and hydroxyethyl cellulose (HEC) to retain N.

Another embodiment of Applicant's invention involves polymer coatings formed on NPK fertilizer granules for controlled-release of the fertilizer, where the polymer coatings are comprised of polysulfone (PSF), cellulose acetate (CA) and polyacryoInitrile (PAN). The advantages of the use of controlled-release fertilizers include an increase in their efficiency, a reduction in soil toxicity, minimizing the potential negative effects associated with overdosage, and reduction in the frequency of fertilizer application. Coatings of polysulfone (PSF) exhibit low porosity and increased compaction. The thin outer skin layer formed on top of the coating is more compact and dense than the inner portion of the coating and acts as a barrier in reducing the intragranular diffusion of water from soil, the dissolution of ingredients, and transfer outside of the encapsulated granule. An inner layer of the coating is spongy in nature and has the structure of a macroporous honeycomb with large pores. The coatings prepared from solutions of higher polymer concentrations exhibit a lower porosity. A fertilizer membrane dissolves and diffuses into the polymer solution which forms the outer membrane coating.

Applicant's invention further contemplates an agrochemical composition with enhanced activity and phase stability comprising glyphosate in the amount of about ≦25%; one or more lipophilic solvents in the amount of about ≦80%; one or more lipophobic plant nutrients in the amount of about ≦50%; and one or more oil soluble bases in the amount of about ≦50%. The oil soluble base is preferably in the form of a lipophilic solvent soluble complex, such as in the form of fatty amines, with glyphosate capable of coupling, or assisting coupling of, the lipophobic plant nutrients, such as ammonium salts of inorganic anions, with the lipophilic solvents. The polar nature of glyphosate and ammonium sulfate prevents the formulation of useful compositions which include lipophilic solvents since glyphosate and ammonium sulfate are essentially insoluble in lipophilic solvents. This problem is solved with the introduction of an oil soluble base to form a lipophilic solvent soluble complex with glyphosate which encompasses lipophilic plant nutrients with the lipophilic solvents. Various adjuvants may be used in this embodiment of the invention including ammonium salts, wetting agents, spray drift retardants and lipophilic solvents, as well as various organic acid herbicides such as glyphosate, chloroacetic acid, flamprop, fosamine, sulfometuron and triflusulfuron. Various lipophilic solvents, plant nutrients, oil soluble bases, micro-emulsions, nonionic and cationic emulsifiers may also be used in accordance with this embodiment of the invention. This agrichemical composition is also useful with adjuvants such as pH modifiers, spray drift retardants and wetters. Finally, various lipophilic solvents, plant nutrients, organic acids and oil soluble bases may also be used in accordance with this embodiment of the invention.

Another embodiment of Applicant's invention contemplates an agent for increasing the activity of agrichemicals and controlling their drift using a specially formulated deposition agent with a fertilizer. The advantages of this agent are that it (1) allows the use of lower agricultural use rates because of the increased activity of the agrichemicals, and (2) improves the deposition of the sprays. The prior art made use of drift reducing agents such as polyacrylamides, polyvinyl polymers and natural gums, such as guar gum. The prior art also made use of silicone defoamers. This embodiment of the invention addresses the high percentage of use of products in dry form, the use of lower levels of polyacrylamide polymer, the large amounts of nitrogenous fertilizers used, and the high cost of guar gum. This embodiment of the invention contemplates the use of reduced amounts of nitrogenous fertilizers such as in the form of various ammonium compounds, urea compounds, potassium compounds, phosphate compounds and increased amounts of natural gums such as non-derivatized guar gum. The benefits of natural gums in liquid oil-based compositions are that they provide the same benefits as the fertilizer itself, as well as providing increased pesticide efficacy and easier use of the deposition and drift control agent, with minimal or no use of silicone drift agents. The invention also makes use of buffering agents such as citric acid, Agrho DR-2000 (modified guar gum), and mono-potassium phosphate (MKP) for the additional benefits which these types of components provide.

More specifically, this embodiment of Applicant's invention contemplates the combination of at least one oil and a natural gum, which may be in the form of non-derivatized guar gum, cationic guar gum, non-cationic guar gum, or mixtures thereof. This composition also includes less than 10% by weight water in the composition, with the liquid composition combined with a pesticide, and in some cases oil may be present in the composition in an amount greater than the water or the oil can take on various forms such as an alkylated fatty acid ester, a hydrocarbon oil, an alkylated natural oil or a fatty acid.

Another embodiment of the invention is directed to the control of aerial spray or discharge drift in aqueous compositions by means of the use of selected non-visco-elastic amounts of guar, one or more derivatives of guar, or combinations thereof. More specifically, this embodiment contemplates a method for reducing drift during aerial spraying by admixing with an aqueous composition prior to spraying or discharge from 0.075 to less than 0.2% weight per unit volume at final dilution of a drift control agent consisting of non-derivatized guar, and aerial spraying or discharging the admixture. The prior art makes use of visco-elastic polyacrylamides, etc., as polymer drift control agents, but these compositions suffer from a very limited effective time of positive drift reduction because of the typical use of a kerosene carrier, the non-biodegradable nature of the polymers themselves, the requirement to use specific organic inverting surfactants with these polymers to enable them to be properly hydrated and disbursed in water, and the requirement to use plastic or glass containers. This embodiment of the invention contemplates the use of guar and derivatives of guar used in an aqueous spray medium as drift control agents with none of the above-discussed disadvantages associated with the prior art use of polyacrylamide agents. The guar-water combinations exhibit Newtonian liquid behavior and reduce the number of droplets below about 150 microns in diameter, which are the droplets most responsible for drift problems. The guar materials are biodegradable, dry and thus not subject to separation upon storage, not freeze sensitive, and do not require volatile organic compound carriers or surfactants to effect rapid hydration and water. The guar acts as a lubricant, binder, thickener and suspension agent. The preferred droplet size is in the range of 200-500 microns. Simulated field studies have shown that derivatized guar, both sheared and unsheared, can reduce drift as effectively as the sheared or unsheared polyacrylamide drift control standard.

More specifically, this embodiment of the invention contemplates a method for reducing drift during aerial spraying or discharge of an aqueous composition containing a major amount of water and essentially no drift control agents. The inventive method comprises admixing with the composition prior to the spraying or discharge a specific range of weight per unit volume at final dilution of a sole drift control agent, followed by aerial spraying or discharging of the admixture. The weight per unit volume ranges are very small, i.e., the largest is 0.05 to 0.275%. The amount of the sole drift control agent depends upon the type of guar material being used. For example, the invention calls for the use of 0.075 to less 0.20% weight per unit volume of a non-derivatized guar; the use of 0.075 to 0.275% weight per unit volume of non-cationic guars; the use of 0.075 to 0.275% weight per unit volume of hydroxyl propyl guar; the use of 0.075 to 0.275% weight per unit volume of carboxymethyl hydroxylpropyl guar; the use of from 0.05 to 0.1% weight per unit volume of cationic guar; and the use of 0.05 to 0.275% weight per unit volume of a sole drift control agent selected from the group consisting of non-derivatized guar, one or more cationic guars or non-cationic derivatized guars, and combinations thereof with the proviso that the cationic guar concentration should not exceed 0.1% weight per unit volume and that the non-derivatized guar concentration should not exceed 0.25% weight per unit volume.

Another embodiment of the invention relates to a free-flowing, powder fertilizer composition with enhanced aqueous dissolution rates and reduced drift characteristics in an aqueous agricultural spray medium. The compositions are comprised of water-soluble, nitrogen-containing fertilizer blended with a guar gum drift reduction agent and a silicone defoaming agent either encapsulated or absorbed in an agricultural carrier such as a starch. This embodiment provides enhanced hydration rates and the reduction of agglomeration and gellation realized by physical pre-blends of water-soluble nitrogen-containing fertilizers and the guar gum drift reduction agents which are sustainable even when the blend is introduced rapidly into a highly agitated, aqueous agricultural medium if a silicone defoaming agent, either encapsulated or absorbed in the agriculturally acceptable carrier, is incorporated therein. This embodiment incorporates a water-soluble nitrogen-containing fertilizer such as ammonium sulfate, i.e., diammonium sulfate, but also contemplates use with other ammonium salts, ammonium phosphates, ammonium nitrates and substituted ureas. Dedusting agents may also be used in these free-flowing fertilizer compositions and may be comprised of amides, esters, ethoxylates, end-capped and EO/PO block copolymers and silicone containing surface active agents.

More specifically, this embodiment of Applicant's invention contemplates a composition of about 87.5-99.8 weight percent of a water-soluble nitrogen-containing fertilizer, such as diammonium sulfate, in combination with about 0.01 to about 12.49 weight percent of a drift reduction agent taken from the group of non-derivatized guar gum, non-cationic derivatized guar gum, cationic guar gum, hydroxyl propyl guar gum, carboxy methyl hydroxylpropyl guar gum, and mixtures thereof. The composition further includes from about 0.01-12.49 weight percent of a silicone defoaming agent either encapsulated or absorbed in an agriculturally acceptable carrier such as, for example, starch encapsulated dimethyl polysiloxane. Other defoaming agents such as polysiloxane-based defoaming agent, or a vegetable oil or mineral oil defoaming agent may be used in this embodiment of the invention. An agriculturally acceptable carrier for use in this embodiment of the invention may be in the form of an inorganic solid sorbent carrier such as clay, finely ground haolin, talcum, chalk, limestone, attapulgite, pumice, precipitated silica, pyrogenic silica, fumed silica, attaclay, dolomite, diatomaceous earth, or a combination thereof.

Another embodiment of Applicant's invention contemplates a free-flowing fertilizer with improved deposition/drift characteristics in the form of a combination of a powdered, water-soluble nitrogen containing fertilizer and a drift reduction agent with a 25-95.5 percent weight percent of the nitrogen containing fertilizer and a 0.05-1.5 percent by weight of the polyacrylamide liquid emulsion/dispersion drift reduction agent. This embodiment further envisions a composition containing 0.1-3.0 percent by weight of a polyacrylamide powder whose particle size is in the range of 50-100 mesh in size. This invention addresses the problem of high sensitivity to shear of polyacrylamide dry systems which results in reduced performance as the tank mix is re-circulated through the pumping system. By combining a dry milled polyacrylamide having a specified range of particle size with a liquid polyacrylamide emulsion/dispersion, differing rates of hydration from the different systems are used to extend the time of control under different shear rates through the pumping system. The nitrogen containing fertilizer particles are milled to the proper size by controlling the resonance time in the mill and the type of screen is selected to reduce the fertilizer particle size to the range of about 50-100 mesh. Once the fertilizer is milled to the proper particle size, it is placed in a ribbon blender where the other components of the composition are added.

This embodiment covers the combination of 25-99.5 percent by weight of a powdered, water-soluble nitrogen containing fertilizer, 0.05-1.5 percent by weight of a polyacrylamide liquid emulsion/dispersion, and 0.1-3.0 percent by weight of a polyacrylamide powder having a particle size of 50-100 mesh. This embodiment further contemplates the inclusion of powdered silicone defoamers, a nonionic powdered surfactant, a sequestering agent, and anti-caking compounds. This invention further covers the aforementioned ranges by weight of the various components of the free-flowing, powder fertilizer, as well as the additional steps of adding the aforementioned additional components and the steps of passing the dry-blended powder through a screening device to remove unground particles.

The next embodiment of Applicant's invention relates to liquid fertilizer blends and more specifically to a dry granular fertilizer and a method for fertilizing plants by providing alkanoic acids or their salts on a dry carrier placed close to the root zone of young plants or directly on plant seeds. The dry fertilizer blend is comprised of a dry granular fertilizer comprising alkanoic acid or a salt thereof applied on a dry carrier, which is not a fertilizer composition containing nitrogenous, phosphatic or potash fertilizers, deposited on or into the ground in the vicinity of the plant's roots. The alkanoic acids, or salts thereof, are preferably C₁ to about C₆ alkanoic acids. The dry carrier is a granular carrier having an average particle size greater than about 50 mesh, or less than about 50 mesh. One example of a carrier included in this list is guar gum. This embodiment of the invention also contemplates spraying the liquid ingredients onto a dry carrier which absorbs the liquid spray and becomes a dry fertilizer.

This embodiment of the invention further contemplates a method of fertilizing a plant comprising applying a liquid comprising C₁ to about a C₆ alkanoic acid, or a salt thereof, onto a dry carrier to form a dry granule and placing the granule into the ground in the vicinity of the plant's roots, wherein the dry carrier is not a fertilizer composition containing nitrogenous, phosphatic or potash fertilizers.

Another embodiment of Applicant's invention is directed to a composition and method for increasing the solubility of various agricultural compounds in water at low pH. These compounds are normally not soluble with pH≦7. This invention uses a homogenous agricultural liquid composition containing the combination of an acidic ester surfactant; and an amine containing a surfactant, preferably a fatty amine ethoxylate surfactant, a phosphate ester surfactant, or a tallowamine ethoxylate surfactant; and at least one other water soluble agricultural chemical, e.g., a herbicide, to increate the solubility of various agricultural compounds in low pH water. By lowering the pH to ≦7, the solubility of the agricultural chemical increases in water. The composition consists of at least of one acid ester surfactant such as a phosphate ester of nonyl- or octylphenol ethoxylates. The amine containing surfactant is disclosed as being a fatty amine alkoxylate such as tallowamine ethoxylate with pH≦7. This invention also includes at least one acid ester surfactant, at least one amine containing a surfactant, and at least one water soluble agricultural chemical.

Another embodiment of Applicant's invention is also intended to increase the solubility of agricultural compounds in water at low pH, where the compounds are typically not soluble in water having a pH<7. However, in this invention a phosphate ester surfactant is not used. In this embodiment, amine containing surfactants and organic acids lower the pH of the solution of various compounds and maintain these compounds soluble in water. The amine containing surfactant is preferably a fatty amine alkoxylate which is derived from the sequential addition of ethylene oxide and optionally propylene oxide to ethylenediamin. More specifically, this embodiment comprises the combination of phosphorous or phosphoric acid or carboxylic acid in an eye irritating amount, an amine containing surfactant, and at least one water soluble agricultural chemical, with the proviso that the entire composition contains no phosphate ester surfactant.

Another embodiment of the invention is directed to a homogenous adjuvant composition containing at least an alkanolamide surfactant and optionally other surfactants or pesticides or formulation aids at pH of 7 and preferable at least about 8. The surfactant is preferable reacted with a fatty acid without the use of alkoxylation (or ethoxylation or propoxylation). When mixed with other pesticide mixtures, the invention enhances spreading of the applied droplets and reduces the tendency for the dried deposit being washed off of plant surfaces by rain or heavy dews. This inventive composition is a “spreader”, i.e., it increases the area that a droplet will cover on a target, and a “sticker”, i.e., a material that assists the spray deposit to adhere, or stick, to the target plant as measured in resistance to time, wind, water, mechanical action, or chemical action. The pH of the adjuvant is possibly either acidic or basic, and is preferably at least 8. Examples of the surfactants useful in this invention include sorbitant fatty acids and their esters and derivatives, silicone surfactants, ethoxylated fatty acids, alkylethoxylates and phosphate or carboxylate acid esters thereof, polypropylene and polyethylene glycols, and block co-polymers of ethylene oxide and propylene oxide and phosphate or carboxylate acid esters thereof. Also useful in this embodiment of the invention are non-ethoxylated or non-propoxylated alkanolamide surfactants of specific structures. These surfactant structures detail the compositions in terms of hydrogen, hydrocarbons, alcohol and various radicals R, where the pH is 7 or less. The non-ethoxylated or non-propoxylated alkanolamide has the general formula:

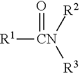

### Where:

R₁ is a C₁-C₄₀ hydrocarbon; R₂ is a hydrogen or

CₓH₂ₓOH where x equals 1-40; and

R³ is C_{x′}H_{2x′},OH where x′ equals 1 or 4-40.

Another embodiment of Applicant's invention is directed to an adjuvant composition comprising 100 parts by weight (“pbw”) of 25-95 pbw of polysaccharide (such as in the form of derivatized or non-derivatived guar), and 75-20 pbw of a salt composition (such as a cation selected from an alkali metal cation, an alkaline earth cation, a quaternary ammonium cation, or diammonium hydrogen phosphate, sodium carbonate, and a combination thereof. The adjuvant composition is capable of hydrating in a heel solution. The prior art in this area includes dry adjuvant compositions generally comprised of more than 85% of diammonium sulfate and less than about 10%, typically 5%, guar by weight of the total composition. The problem with this composition is the large amount of diammonium sulfate required and its high cost. These guar-based drift control dry adjuvant compositions of the prior art are characterized by insufficient disbursement of the dry guar gum due to the agglomeration and lumps of guar gel, or “fish-eyes,” which can also lead to clogging of the spray nozzles during spray application. This invention embodiment lowers the amount of diammonium content and increases the amount of polysaccharide, or guar. The pH of the composition is between 7 and about 10. The adjuvant composition preferably includes a disbursing agent such as sodium polyacrylate, potassium polyacrylate, a sodium salt of polycarboxrylic acid, sodium 2-ethane-1-sulphonate, or combinations thereof. More specifically, this embodiment of Applicant's invention includes an adjuvant composition, or a method for forming an adjuvant composition, based on 100 pbw of the adjuvant composition, including from about 25-75 or 95 ppw of a polysaccharide, and from about 75-5 ppw of a salt composition, where the composition is capable of hydrating in a heel solution, and where an aqueous solution of the adjuvant composition has a pH value of between about 7 and about 10.

Another embodiment of Applicant's invention has as its goal to improve the chemical and physical properties of a pesticide such as an herbicide, insecticide or fungicide in spray form. To improve these types of products, the invention incorporates at least one spray oil. The purpose of these adjuvants is to address application problems such as chemical stability, incompatibility, solubility, suspension, foaming, drift, evaporation, volatilization, phytotoxicity, surface tension, droplet size and coverage, and to enhance wetting, spreading, sticking, emulsifying, disbursing and biological activity. This embodiment specifically incorporates a non-aqueous adjuvant composition comprising a spray oil, a surfactant and a buffering agent in an amount to reduce the pH to below about 7. The spray oil component includes at least one spray oil selected from the group consisting of:

(a) esterified fatty acids or blends thereof;

(b) saponified fatty acids or blends thereof;

(c) vegetable oils;

(d) fatty acids and blends thereof;

(e) N,N-dimethylamide; and

(f) polybutenes.

The surfactant component includes at least one surfactant selected from the group consisting of:

(a) ethoxylated fatty acids;

(b) alkylphenol ethoxylates;

(c) alkyl ethoxylates;

(d) fatty alkanolamides;

(e) PEG esters;

(f) silicone surfactants;

(g) polypropylene glycols;

(h) amine ethoxylates; and

(i) tristyrylphenol alkoxylate.

The preferred buffering agents include but are not limited to:

(a) citric acid;

(b) glutaric acid;

(c) gluconic acid;

(d) lactic acid;

(e) glycolic acid;

(f) alkyaryl polyethoxy phosphate ester;

(g) C₁-C₆ carboxylic acids;

(h) C₁-C₆ dicarboxylic acids;

(i) phosphoric acid;

(j) ethoxylated alkylayl phosphate esters;

(k) ethoylated alkylphenol carboxylate esters;

(l) acrylic acid;

(m) carboxylated alcohol ethoxylate, preferably of the formula

R—O(CH₂CH₂O)χ,H
R is a carboxylic acid having from 1 to about 25 carbon atoms and χ is from 1 to about 20 moles ethylene oxide

(n) tristrylphenol alkoxylate phosphate esters; and

(o) tristryphenol alkoxylate carboxylate esters.

Another embodiment of Applicant's invention is directed to producing a dry-bonded nonionic surfactant/fertilizer adjuvant system comprising spray-coating dry water-soluble, nitrogen-containing fertilizer particles, preferably of diammonium sulfate, with the surfactant composition and the coated compositions produced thereby. These surface adjuvants are hydrophilic enough to stabilize the herbicide in water and lipophilic enough to penetrate the cuticle of a leaf. In the form of a moist gel, these types of surfactants form monolayers on the leaf surfaces with the lipophilic portion forming “hydrophilic channels” through leaf surface imperfections such as cracks, punctures, and pores, with these channels absorbing water and slightly swelling to allow herbicides to diffuse through the cuticle into the cell walls. The preferred surfactants when mixed with pesticides in an aqueous medium are nonionics, which tend to dissolve rather slowly. Herbicidal efficacy is enhanced when mixed with dry water-soluble nitrogen fertilizers such as urea, ethylurea, mono- and diammonium phosphate, mono- and diammonium sulfate, and mixtures thereof. Diammonium sulfate can be added in solutions with glyphosate to enhance its herbicidal efficacy. As a result of the above, attempts have been made to pre-blend individual fertilizer, surfactant and other adjuvant components as an aid to the end-user farmer. However, the slow aqueous dissolution rate of solid nonionics, the significant differences in particle sizes among the individual components, and the inherent tackiness of particle fines have resulted in problems in the preparation and use of these types of solid, nonionic surfactants in water-soluble fertilizer delivery systems. This embodiment of the invention overcomes these problems by providing a single particle fertilizer-nonionic surfactant carrier to increase aqueous dissolution rates, and also to allow for incompatible components to be incorporated into a single particle to allow for preferential sequential exposure of selected components to the aqueous media. This embodiment of the invention is directed to a method for preparing a dry, water-soluble nitrogen fertilizer coated with solid nonionic surfactant compositions, and the resulting granule, by spray-coating a molten surfactant composition onto from 70 to about 99 weight percent dry water-soluble, nitrogen-containing fertilizer, preferably in the form of diammonium sulfate crystals, with the aforementioned weight percentages based on the final weight of the dry bonded adjuvant granule.

More specifically, this embodiment of the invention is directed to a method for producing a dry bonded adjuvant system comprising mixing dry water-soluble nitrogen-containing fertilizer particles; melting a solid nonionic surfactant and spray-coating the dry water-soluble, nitrogen-containing fertilizer particles with the molten nonionic surfactant composition; and cooling the coated particles, wherein the fertilizer comprises from about 70-99 weight percent of the adjuvant system and the surfactant composition comprises from 1-30 weight percent of the adjuvant system, where the weight percents are based on the total adjuvant system weight.

Another embodiment of the invention is directed to a homogeneous, essentially non-aqueous adjuvant composition comprising a spray oil having a minimum of 92% unsulfonated residue such as paraffin oil, and a surfactant blend consisting of sorbitan fatty acid ester and a polyethoxylated sorbitan fatty acid ester in a weight ratio of 1:3. The adjuvant composition further includes an alkylaryl polyethoxyl phosphate ester as a buffering agent in an amount sufficient to reduce the pH to the range of 4-6. When mixed with a pesticide, this composition provides a one-step addition of the adjuvants to obtain a more uniform spread of the spray solution of the herbicide or pesticide, improved plant penetration, and slower evaporation. The buffering agent maintains the pH of the mixture within a desired range in the alkaline waters typically used in agricultural spray solutions to prevent hydrolysis of the pesticide. In addition, this inventive composition is 80-85% by weight spray oil and the surfactant blend is 15-20% by weight, with the water content preferably less than about 8% by weight of the total composition weight. The purpose of this embodiment is to provide an essentially non-aqueous, single-phase adjuvant composition containing oil plus surfactant blend which provides a buffering capability. This embodiment further contemplates a non-aqueous adjuvant composition consisting essentially of a spray oil having a minimum of 85% of unsulfonated residue (UR) value, and a surfactant blend selected from a group consisting of:

(a) silicone surfactants;

(b) ethoxylated fatty acids

(c) alkyl ethoxylates;

(d) fatty alkanolamides;

(e) PEG esters

(f) amine ethoxylates

(g) alkylphenol ethoxylates; and

(h) polypropylene glycols.

Another embodiment of Applicant's invention is directed to a homogeneous essentially non-aqueous adjuvant composition comprising at least one spray oil, a surfactant in the amount sufficient to provide for the emulsification of the composition, and a buffering agent which can also be the same ingredient as the spray oil or as the surfactant, and which reduces the pH of the composition to about 7 or below. At least one spray oil is selected from the group of: vegetable oils; fatty acids and blends thereof; esterified fatty acids and blends thereof; saponified fatty acids and blends thereof; N,N-dimethylamide having a specific formula; polybuten; alpha or beta pinene; thymol; d-limonene; and jojoba bean oil. This embodiment also includes various adjuvants that solve various problems as well as petroleum hydrocarbon spray oils which increase the efficacy of herbicides, fungicides, and other pesticides. The purpose of this invention is to provide an essentially non-aqueous single-phase adjuvant composition containing oil plus a surfactant blend which provides a buffering capability even with the addition of alkaline water and pesticides, and which reduces and/or maintains the pH of the spray mixture within a desired range to prevent hydrolysis of the pesticide. The spray oil and/or the surfactant component itself may be used in lieu of a buffering agent provided that the spray oil and/or surfactant reduces the pH of the composition to below 7. Some spray oils when coupled into water, can also provide buffering on their own. This composition provides uniform spread of the spray solution of the herbicide or pesticide to provide improved plant penetration and slower evaporation. The adjuvant can also be used as a pesticide or herbicide without the addition of any additional pesticide to the adjuvant. An important aspect of this embodiment is to maintain the pH of the mixture within a desired range below about 7 in the presence of the alkaline waters typically used in spray solutions. The spray oil is preferably a single spray oil or a mixture of spray oils selected from the group consisting of:

(a) esterified fatty acids or blends thereof;

(b) saponified fatty acids or blends thereof;

(c) vegetable oils;

(d) fatty acids and blends thereof;

(e) alpha or beta pinene;

(f) N,N-dimethylamide;

(g) polybutenes also having a specified formula;

(h) thymol; and

(i) d-limoneme.

A surfactant provides emulsification of the composition. The final component is a buffering agent, wherein the buffering agent can also be the same ingredient as that of the spray oil or as that of the surfactant, with the buffering agent reducing the pH of the composition to about 7 or below.

Another embodiment of the invention contemplates a method for increasing the activity of chlorinated phenoxy herbicides in acid, ester or salt form by providing them with a combination of solvent and selected surfactants. The solvent is at least one alkylated fatty acid, alkylated plant-derived oil, or alkylated animal-derived oil. The selected surfactants include at least one surfactant from the group including sorbitan fatty acids, sorbitan fatty acid esters, ethoxylated sorbitan fatty acid esters, propoxylated fatty acid esters, and silicon surfactants. Chlorinated phenoxy acid compounds comprising a family of herbicides are used in the form of their parent acids, and also as their salts and esters. The preferred member of this herbicide family is 2,4-D [(2,4-dichlorophenoxy)]acetic acid. This embodiment of the invention provides a synergistic effect in allowing a reduction of herbicide use rates on a per acre basis. This is in contrast to prior approaches based upon the belief that the uptake of chlorinated phenoxy herbicides is directly associated with the concentration of the herbicide on the plant leaf surface. The preferred embodiment includes chlorinated phenoxy herbicides, alkylated fatty acids or natural oils, including but not limited to: alkylated soybean oil, alkylated sunflower oil, alkylated canola oil, and alkylated fatty acids including C₆₋₁₈ saturated and unsaturated fatty acids.

More specifically, this embodiment contemplates the combination of at least one chlorinated phenoxy herbicide, and at least one alkylated fatty acid, an alkylated plant derived oil, or an alkylated animal derived oil. This embodiment further contemplates a composition of at least one chlorinated phenoxy herbicide and surfactant, in combination with at least one alkylated fatty acid, alkylated plant derived oil or alkylated animal derived oil.

Another embodiment of the invention is concerned with the problem of mixing a herbicide, such as glyphosate, or other active products such as plant hormone insecticides, crop desiccants or crop defoliants, with various adjuvants. It is known that formulations of glyphosate and ammonium sulfate can be readily produced because both of these substances are water soluble. However, the polar nature of glyphosate and ammonium sulfate has prevented the formulation of useful compositions which include lipophilic solvents since glyphosate and ammonium are essentially insoluble in lipophilic solvents which are capable of maintaining a herbicide in liquid form, as the herbicide will be ineffective if it dries on the foliage. This embodiment maintains the herbicide in liquid form so that it can penetrate into the plant by providing an agrochemical composition with enhanced activity and phase stability comprising glyphosate present in an amount not in excess of about 25%, one or more lipophilic solvents present in an amount not in excess of about 80%, one or more lipophobic plant nutrients present in an amount not in excess of about 50%; and one or more oil soluble bases present in an amount not in excess of about 50%. The oil soluble base forms a lipophilic solvent soluble complex with glyphosate which is capable of coupling or assisting coupling of the lipophobic plant nutrients with the lipophilic solvents. The lipophilic solvents are alkyl esters of fatty acids, while the lipophobic plant nutrients are ammonium salts of inorganic ions. The oil soluble bases are fatty amines, fatty ammonium hydroxides, and fatty betaines. The ammonium salts minimize the deleterious effects of hard water on herbicidal performance and provide plant nutrients which enhance herbicidal performance. Wetting agents improve the leaf coverage of the herbicide. Lipophilic solvents keep the herbicide in liquid form as the herbicide will be ineffective if it dries on the foliage and also assist the penetration of the herbicide into the plant.

Another embodiment of the invention is directed to a formulation of dimenthoate that is water soluble, highly active and tolerant of low temperatures for use as a pesticide. This solvent system does not require an emulsifier and is less toxic than known solvents. Previously dimenthoate has been mixed with xylene hydrocarbons and cyclohexanone as a solvent system since dimenthoate is insoluble in water. But these formulations have limitations in terms of the amount of dimenthoate which can be dissolved, the toxicity and environmental hazards of xylene hydrocarbons and cyclohexanone, and the relatively high freezing points (35°-45° F.) of these formulations. Prior emulsions were not stable for long periods and tended to stratify. Poor agitation of these prior art solvents could result in separation of dimenthoate from the emulsion.

The insecticide form of this pesticide consists of an effective amount of O,O-dimethyl S—(N-methylcarbanyl)phosphorodithioate in a solvent system comprising an effective amount of the mixture of an aliphatic C₁-C₄ alcohol and an acetate ester of an aliphatic e C₁-C₄ alcohol. This embodiment of the invention further contemplates an insecticide formulation consisting of about 45% to about 60% by weight of a formulation of O,O-dimethyl S—(N-methylcarbanyl)phosphorodithioate in a solvent mixture of ethyl acetate and ethanol present in a weight ratio of 20:80.

Another embodiment of the invention relates to a method for manufacture and use of a herbicidal formulation containing the free acid form of glyphosate and an acid. More specifically, this herbicidal formula includes phosphoric, citric, acetic, propionic, and phosphorous acid and their corresponding salts which allow for lower glyphosate use rates than standard formulations. Too much acidity in these types of herbicide formulations may result in precipitation of the glyphosate. This embodiment contemplates the use of the various relatively weak acids listed above with glyphosate in a herbicide which allows for lower glyphosate usage rates than standard formulations. This formulation can be further enhanced with the addition of a surfactant component for reducing the surface tension of the water to allow the water and herbicide to penetrate the outer skin of undesirable vegetation.

This inventive liquid herbicidal concentrate includes glyphosate in free acid form and at least one acid component selected from the following group:

(a) a neutralized organic acid;

(b) phosphoric acid;

(c) phosphorus acid (H₃PO₃);

(d) salts of phosphoric acid; and

(e) salts of phosphorous acid, and optionally a surfactant.

Another embodiment of this invention is directed to a composition containing hexazinone which is a commonly used agricultural and forest management herbicide, in combination with an alkylene carbonate which are good solvent systems for hexazinone formulations. The addition of the alkylene carbonates allows these hexazinone formulations to be used without freezing down to temperatures on the order of 15° F., and it also renders these compositions non-flammable. These compositions can be used without conventional defoamers, and can also be used without alternate foam control agents, such as, silica based defoamers. The preferred herbicide formulation contains at least 25%-30% by weight of hexazinone based on the total weight of the composition. The alkylene carbonate is preferably selected from butylene, ethylene, propylene or glycerin carbonates. The amount of alkylene carbonate in this composition is from 10-99% by weight. More preferably, the alkylene carbonate is present in an amount between 50-80% by weight, and not preferably 70-80% by weight. These compositions do not require the use of surfactants. Generally, this embodiment contemplates a herbicidal composition comprising hexazinone and (1) alkylene carbonate sufficient to solubolize the hexazinone with no surfactant; (2) alkylene carbonate with the composition not forming an emulsion; and (3) alkylene carbonate wherein the composition is water miscible, respectively.

Another embodiment of the invention is directed to surfactant systems and in particular to herbicidal compositions comprising a water soluble herbicide and/or a salt thereof, and a surfactant system. The surfactant system comprises at least two surfactants selected from the group consisting of: (1) alkyldiamine, tetraalkoxylate surfactants; (2) N-alkyldiamine, trialkoxylate surfactants; and (3) phosphated alcohol alkoxylate surfactants. The advantages of these compositions are that they provide increased herbicidal efficacy, with low aquatic toxicity and low irritancy to skin and eyes.

Another embodiment of the invention is directed to surfactant adjuvants that improve the bio-efficacy of herbicides by combining known wetting characteristics of sulfosuccinate or sulfosuccinamate-based surfactants, with the proven bio-efficacy characteristics of alkoxylated amine-based surfactants. The surfactant adjuvants contain an amine-based surfactant, and a sulfosuccinate or sulfosuccinamate-based surfactant. The surfactant adjuvants are combined with herbicidal active ingredients, and possibly one or more formulation aids, to form herbicide compositions having a reduce tendency to cause eye and skin irritation and can be used to control unwanted weeds or vegetation. More specifically, this embodiment contemplates the combination of a herbicide in combination with a surfactant component comprising an amine-based surfactant and a sulfosuccinate or sulfosuccinamate-based surfactant which is in an amount sufficient to enhance the effectiveness of the herbicidal active ingredient. This embodiment further contemplates the blending of a surfactant component comprising an amine-based surfactant and a sulfosuccinate or sulfosuccinamate-based surfactant in combination with the step of mixing a sufficient amount of the surfactant component with a herbicidal active ingredient to enhance the effectiveness of the herbicidal active ingredient, where the herbicidally effective composition has a reduced tendency to cause eye and skin irritation.

Another embodiment of the invention is directed to surfactants for herbicides comprised of esterified alkoxylated polyether diamines, alkoxylated polyether diamines, and mixtures thereof. The function performed by these surfactants is that they overcome the effect of the active herbicide which often interferes with absorption of the herbicide into the vegetation. The aforementioned adjuvants in this invention facilitate and promote absorption of the herbicide into the vegetation and thus improve the efficacy of the herbicide. The surfactants of this invention not only enhance the absorption of the herbicide in the vegetation by increased amine content, but they also facilitate application of the herbicide to the vegetation by lowering the volatility of the herbicide composition, producing cloud points at or about 65° C., the commercial standard of glyphosate herbicide solutions. A sufficient amount of a neutralizing agent is added to the surfactant to neutralize any residual basicity and to provide a pH of about 7. These herbicidal compositions may be applied to vegetation in either liquid or solid composition, or may be painted on the trunk portion of the vegetation to be treated. More specifically, this embodiment contemplates a herbicide composition including a herbicidal active ingredient in combination with a surfactant component that enhances the effectiveness of the herbicidal active ingredient, where the herbicidal active ingredient may be glyphosate or a salt thereof, and the surfactant is either alkoxylated polyether diamines, esterified alkoxylated polyether diamines, or mixtures thereof.

While particular embodiments of the present invention have been shown and described, it will be apparent to those skilled in the art that changes and modifications may be made without departing from the invention and its broader aspects. Therefore, the aim in the appended claims is to cover all such changes and modifications as fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A method for preparing an agricultural composition for use with a foliar chemical, pesticide, fertilizer and/or bio-active agent comprising the steps of:
providing water purified to have on the order of about 1 to 100 ppm total dissolved solids by substantially removing hardness and alkalinity from unpurified water;
providing the purified water with a pH≦7 to prevent hydrolysis, increase the water solubility, and enhance plant and pest absorption, adsorption and translocation of the pesticide, fertilizer and/or bio-active agent;
adding a buffering agent to the purified water to reduce divalent metal ion concentration of the purified water and increase the efficacy of the pesticide, fertilizer and/or bio-active agent; and
adding to the purified water either in combination or in the alternative ammonium salts including urea ammonium nitrate, wetting agents, spray drift retardants, lipophilic solvents, oil soluble bases, micro-emulsions, nonionic and/or cationic emulsifiers, defoaming agents and organic acids.

2. The method of claim 1, wherein the step of providing purified water includes, either individually or in combination, the following water processing steps:
deionization, reverse osmosis, ultra-, micro- and nano-filtration, distillation, such as steam distillation, and/or electrolysis.

3. The method of claim 1, further comprising the step of adding a spray oil to the agricultural composition for facilitating application of the agricultural composition in spray form on plants.

4. The method of claim 3, wherein said spray oil is selected from the group consisting of:
(a) esterified fatty acids or blends thereof;
(b) saponified fatty acids or blends thereof;
(c) vegetable oils;
(d) fatty acids and blends thereof;
(e) alpha or beta pinene;
(f) N,N-dimethylamide;
(g) polybutenes;
(h) thymol; and
(i) d-limoneme.

5. The method of claim 1, further comprising a surfactant for stabilizing a herbicide in water and facilitating penetration of a plant leaf.

6. The method of claim 5, wherein said surfactant is selected from the group consisting of:
(a) ethoxylated fatty acids;
(b) alkylphenol ethoxylates;
(c) alkyl ethoxylates;
(d) fatty alkanolamides;
(e) PEG esters;
(f) silicone surfactants;
(g) tristyrylphenol alkoxylate
(h) polypropylene glycols; and
(i) amine ethoxylates.

7. The method of claim 1, further comprising a surfactant for increasing the area that a droplet of the agricultural composition covers on a plant and the time that the droplet adheres to the plant.

8. The method of claim 7, wherein said surfactant is selected from the group consisting of:
(a) sorbitant fatty acids and their esters and derivatives;
(b) silicone surfactants;
(c) ethoxylated fatty acids;
(d) alkylethoxylates and phosphate or carboxylate acid esters thereof;
(e) polypropylene and polyethylene glycols; and
(f) block co-polymers of ethylene oxide and propylene oxide and phosphate or carboxylate acid esters thereof.

9. The method of claim 1, wherein said spray drift retardant is comprised of dry milled polyacrylamide and a liquid polyacrylamide emulsion/dispersion having different hydration rates for reducing the sensitivity of the composition to shear in a pumping system.

10. The method of claim 9, wherein said dry milled polyacrylamide is in the form of particles in the range of 50-100 mesh in size.

11. The method of claim 1, wherein the fertilizer is a water soluble, nitrogen containing fertilizer such as ammonium sulfate, other ammonium salts, ammonium phosphates, ammonium nitrates, and substituted ureas.

12. The method of claim 1, wherein said spray drift retardants are taken from the group comprising: non-derivatized guar gum; non-cationic derivatized guar gum; cationic guar gum; hydroxylpropyl guar gum; and carboxy methyl hydroxylpropyl guar gum, and mixtures thereof.

13. The method of claim 1, wherein said spray retardants are taken in the % weight per unit volume and from the group comprising: 0.075% to less than 0.20% weight per unit volume of a non-derivatized guar; 0.075 to 0.275% weight per unit volume of non-cationic guars; 0.075 to 0.275% weight per unit volume of hydroxyl propyl guar; 0.075 to 0.275% weight per unit volume of carboxymethyl hydroxylpropyl guar; 0.05 to 0.1% weight per unit volume of cationic guar; 0.05 to 0.275% weight per unit volume of a sole drift control agent selected from the group consisting of non-derivatized guar, one or more cationic guars or non-cationic derivatized guars, and combinations thereof with the proviso that the cationic guar concentration not exceed 0.1% weight per unit volume and the non-derivatized guar concentration not exceed 0.25% weight per unit volume.

14. The method of claim 1, further comprising the step of adding a defoaming agent to the agricultural composition wherein said defoaming agent is taken from the group comprising: silicone defoaming agents, polysiloxane-based defoaming agents and vegetable oil, and/or mineral oil defoaming agents.

15. The method of claim 14, further comprising the step of encapsulating said defoaming agent in an agriculturally acceptable carrier.

16. The method of claim 14, wherein said agriculturally acceptable carrier for said defoaming agent is a starch.

17. The method of claim 15, wherein said starch is dimethyl polysiloxane.

18. The method of claim 13, wherein the spray droplet size is in the range of 200-500 microns.

19. The method of claim 3, wherein said spray oil is selected from the group consisting of: an alkylated fatty acid ester, a hydrocarbon oil, an alkylated natural oil or a fatty acid.

20. The method of claim 3, wherein said spray oil forms a lipophilic solvent soluble complex with a pesticide such as glyphosate.

21. The method of claim 1, further comprising the step of adding various adjuvants to the agricultural composition including ammonium salts, wetting agents, spray drip retardants, lipophilic solvents, an/or various organic herbicides such as glyphosate, chloroacetic acid, flamprop, sulfometuran or triflusulfuron.

22. The method of claim 1, wherein said agricultural composition is in the form of fertilizer granules, the method further comprising the step of providing a controlled-release coating on said fertilizer granules.

23. The method of claim 22, wherein said controlled-release coating is comprised of a polymer such as taken from the group of polysulfone, cellulose acetate and polyaclyolnitrile.

24. The method of claim 1, wherein said agricultural composition is a nitrogen fertilizer solution, said method further comprising the step of adding a gel-forming hydrophilic polymer to said nitrogen fertilizer solution to reduce nitrogen leaching loss and increase plant uptake of the nitrogen.

25. The method of claim 1, wherein said agricultural composition is used with a dry-bonded nitrogen fertilizer, the method further comprising a step of spray-coating the dry-bonded fertilizer with a molten nonionic surfactant composition.

26. The method of claim 25, wherein said nitrogen fertilizer comprises about 70-99 weight percent and said nonionic surfactant comprises about 1-30 weight percent of the fertilizer adjuvant system.

27. The method of claim 1, wherein said agricultural composition is used with a dry granular fertilizer, said method further comprising the step of adding granules of a soil conditioner to the agricultural composition.

28. The method of claim 27, wherein said granules of the soil conditioner are comprised of cross-linked polystyrene.

29. The method of claim 1, wherein a step of providing the purified water with a pH≦7 includes adding a buffering agent to the purified water, wherein said buffering agent is taken from the group comprising:
(a) citric acid;
(b) glutaric acid;
(c) gluconic acid;
(d) lactic acid;
(e) glycolic acid;
(f) alkyaryl polyethoxy phosphate ester;
(g) C₁-C₆ carboxylic acids;
(h) C₁-C₆ dicarboxylic acids;
(i) phosphoric acid;
(j) ethoxylated alkylayl phosphate esters;
(k) ethoylated alkylphenol carboxylate esters;
(l) acrylic acid;
(m) carboxylated alcohol ethoxylate, preferably of the formula
R—O(CH₂CH₂O)χ,H
R is a carboxylic acid having from 1 to about 25 carbon atoms and χ is from 1 to about 20 moles ethylene oxide
(n) tristrylphenol alkoxylate phosphate esters; and
(o) tristryphenol alkoxylate carboxylate esters.

30. The method of claim 1, wherein said agricultural composition is used with a non-aqueous pesticide, the method further comprising the step of adding an unsulfonated residue, a surfactant blend and a buffering agent to the agricultural composition to provide uniform spread, improved plant penetration and slower evaporation of the agricultural composition.

31. The method of claim 30, wherein said unsulfonated residue is paraffin oil, said surfactant blend comprises sorbitan fatty acid ester and a polyethoxylated sorbitan fatty acid ester, and said buffering agent comprises alkylaryl polyethoxy phosphate ester to reduce the pH to the range of 4-6.

32. The method of claim 31, wherein said surfactant blend is selected from a group consisting of:
(a) silicone surfactants;
(b) ethoxylated fatty acids
(c) alkyl ethoxylates;
(d) fatty alkanolamides;
(e) PEG esters
(f) amine ethoxylates
(g) alkylphenol ethoxylates; and
(h) polypropylene glycols.

33. The method of claim 1 wherein the agricultural composition includes a chlorinated phenoxy herbicide, said method further comprising the steps of providing the agricultural composition with an alkylated fatty acid, an alkylated plant derived oil and/or an alkylated animal derived oil to facilitate dissolving of the chlorinated phenoxy herbicide in the agricultural composition.

34. The method of claim 33 wherein said chlorinated phenoxy herbicide is 2,4-D[2,4-dichlorophenoxy]acetic acid.

35. The method of claim 1 wherein said agricultural composition includes glyphosate and ammonium sulfate, said method further comprising the step of adding a lipophilic solvent to maintain said glyphosate and ammonium sulfate in liquid form to facilitate penetration of a plant by the agricultural composition.

36. The method of claim 35 wherein said lipophilic solvent is an alkyl ester of a fatty acid.

37. The method of claim 1 wherein the agricultural composition includes the insecticide dimethoate, said method further comprising the step of adding an effective amount of an aliphatic C₁-C₄ alcohol and an acetate ester of aliphatic C₁-C₄ alcohol acetate.

38. The method of claim 37 wherein said agricultural composition is a pesticide including O,O-dimethyl S—(N-methylcarbonyl) phosphorodithioate in a solvent mixture of ethyl acetate and ethanol present in a weight ratio of 20:80.

39. The method of claim 1 wherein said agricultural composition is a liquid herbicide including glyphosate, said method further comprising the step of adding to the agricultural composition a weak acid to increase the efficacy of the glyphosate, wherein the weak acid is taken from the group of:
(a) a neutralized organic acid;
(b) phosphoric acid;
(c) phosphorus acid (H₃PO₃);
(d) salts of phosphoric acid; and
(e) salts of phosphorous acid, and optionally a surfactant.

40. The method of claim 1 wherein said agricultural composition includes hexazinone herbicide, said method further comprising the step of adding an alkylene carbonate to said agricultural composition, wherein said alkylene carbonate is taken from the group of butylene, ethylene, propylene and glycerin carbonates to reduce the freezing temperature of said agricultural composition.

41. The method of claim 1 further comprising the steps of adding to the agricultural composition at least two surfactants selected from the group consisting of:
(1) alkyldiamine, tetraalkoxylate surfactants;
(2) N-alkyldiamine, trialkoxylate surfactants; and
(3) phosphated alcohol alkoxylate surfactants.

42. The method of claim 1 further comprising the steps of adding to the agricultural composition a first sulfosuccinate or sulfosuccinate-based surfactant for improved wetting and a second alkoxylated amine-based surfactant for improved bioeffacacy.

43. The method of claim 1 further comprising the step of adding to the agricultural composition surfactants taken from the group of esterified alkoxylated polyether diamines, alkoxylated polyether diamines, and mixtures thereof for enhancing plant absorption and efficacy of the agricultural composition.

44. The method of claim 43 wherein the agricultural composition is a herbicide having an active ingredient of glyphosate or a salt thereof.

45. A method for preparing an agricultural composition for use with a foliar chemical, pesticide, fertilizer and/or bio-active agent comprising the steps of:
providing water purified to have on the order of about 1 to 100 ppm total dissolved solids by substantially removing hardness and alkalinity from unpurified water;
adding a buffering agent to the purified water to reduce divalent metal ion concentration of the purified water and increase the efficacy of the pesticide, fertilizer and/or bio-active agent; and
adding to the purified water either in combination or in the alternative ammonium salts including urea ammonium nitrate, wetting agents, spray drift retardants, lipophilic solvents, oil soluble bases, micro-emulsions, nonionic and/or cationic emulsifiers, defoaming agents and organic acids.

46. A method for preparing an agricultural composition for use with a foliar chemical, pesticide, fertilizer and/or bio-active agent comprising the steps of:
providing water purified to have on the order of about 1 to 100 ppm total dissolved solids by substantially removing hardness and alkalinity from unpurified water;
providing the purified water with a pH≦7 to prevent hydrolysis, increase the water solubility, and enhance plant and pest absorption, adsorption and translocation of the chemical, pesticide, fertilizer and/or bio-active agent; and
adding to the purified water either in combination or in the alternative ammonium salts including urea ammonium nitrate, wetting agents, spray drift retardants, lipophilic solvents, oil soluble bases, micro-emulsions, nonionic and/or cationic emulsifiers, defoaming agents and organic acids.

47. A method for preparing an agricultural composition for use with a foliar chemical, pesticide, fertilizer and/or bio-active agent comprising the steps of:
providing water purified to have on the order of about 1 to 100 ppm total dissolved solids by substantially removing hardness and alkalinity from unpurified water;
providing the purified water with a pH≦7 to prevent hydrolysis, increase the water solubility, and enhance plant and pest absorption, adsorption and translocation of the pesticide, fertilizer and/or bio-active agent; and
adding a buffering agent to the purified water to reduce divalent metal ion concentration of the purified water and increase the efficacy of the chemical, pesticide, fertilizer and/or bio-active agents.

48. An agricultural solution comprising:
purified water having on the order of about 1 to 100 ppm total dissolved solids and substantially reduced hardness and alkalinity, wherein the purified water has a pH≦7 to prevent hydrolysis, increase solubility, and enhance plant and pest absorption, adsorption and translocation of a pesticide, a fertilizer and/or a bioactive agent disposed in the purified water;
a buffering agent in the purified water to reduce divalent metal ion concentration of the purified water and increase the efficacy of the pesticide, fertilizer and/or bioactive agent; and
an ammonium salt including an urea ammonium nitrate, a wetting agent, a spray drift retardant, a lipophilic solvent, an oil soluble base, a micro-emulsion, a nonionic and/or a cationic emulsifier, a defoaming agent and an organic acid either in combination or individually.

49. An agricultural solution comprising:
purified water having on the order of about 1 to 100 ppm total dissolved solids and substantially reduced hardness and alkalinity;
a buffering agent to reduce divalent metal ion concentration of the purified water and increase the efficacy of a pesticide, a fertilizer and/or a bioactive agent; and
an ammonium salt including an urea ammonium nitrate, a wetting agent, a spray drift retardant, a lipophilic solvent, an oil soluble base, a micro-emulsion, a nonionic and/or a cationic emulsifier, a defoaming agent and an organic acid either in combination or individually.

50. an agricultural solution comprising:
purified water having on the order of about 1 to 100 ppm total dissolved solids and substantially reduced hardness and alkalinity, wherein the purified water has a pH≦7 to prevent hydrolysis, increase solubility, and enhance plant and pest absorption, adsorption and translocation of a pesticide, a fertilizer and/or a bioactive agent disposed in the purified water; and
an ammonium salt including an urea ammonium nitrate, a wetting agent, a spray drift retardant, a lipophilic solvent, an oil soluble base, a micro-emulsion, a nonionic and/or a cationic emulsifier, a defoaming agent and an organic acid either in combination or individually.

51. An agricultural solution comprising:
purified water having on the order of about 1 to 100 ppm total dissolved solids and substantially reduced hardness and alkalinity, wherein the purified water has a pH≦7 to prevent hydrolysis, increase solubility, and enhance plant and pest absorption, adsorption and translocation of a pesticide, a fertilizer and/or a bioactive agent disposed in the purified water; and
a buffering agent in the purified water to reduce divalent metal ion concentration of the purified water and increase the efficacy of the pesticide, fertilizer and/or bioactive agent.
